(19) United States
(12) Patent Application Publication
(10) Pub. No.: US 2006/0113224 A1
(43) Pub. Date: Jun. 1, 2006

(54) Adjustable size sorting apparatus for small produce

(76) Inventor: Robert L. Williamson, Hartford, MI (US)

Correspondence Address: R. TRACY CRUMP, P.O. BOX 604, 32790 DUNN ROAD, NEW CARLISLE, IN, 46552, US

(21) Appl. No.: 10/978,027

(22) Filed: Oct. 29, 2004

(51) Int. Cl. B07C 5/36

(52) U.S. Cl. 209/615; 209/620; 209/621

(57) ABSTRACT

The adjustable size sorting apparatus includes a table-like frame and a longitudinally extending sorting conveyer of parallel elastic bands. The top run of the sorting conveyer is divided into two separate sorting areas. The smaller produce falls through the conveyer across the first sorting area and the remaining larger produce falls through the conveyer across the second sorting area. Since all the produce falls through the conveyer before the end of the top conveyer run, no produce is damaged. A rake mechanism ensures that all the produce falls through the conveyer before reaching the end of the top run. An adjustment mechanism selectively adjusts the relative spacing diagonally between adjacent conveyer bands without changing the spacing horizontally between adjacent conveyer bands.

This invention relates to an apparatus for sorting small produce by size, and in particular, a conveyer type sorting apparatus that prevents small produce, such as blueberries, cherries and cherry tomatoes from being “pinched” or damaged by the size adjustment mechanism.

### BACKGROUND OF THE INVENTION

Size sorting apparatus for small produce, such as blueberries and cherry tomatoes, use a sorting conveyer consisting of a plurality of spaced parallel elastic bands to separate undersized produce from the rest of the produce. When produce is deposited onto the sorting conveyer, the small produce falls through the conveyer between the spaced conveyer bands and the large produce is transported to the end of the sorting conveyer where it is deposited into a collection bin or onto another transport conveyer. Adjusting the spacing between the conveyer bands adjusts the sorting size of the produce. Typically, conventional size sorting apparatus include a mechanism for adjusting the relative spacing between the conveyer bands to selectively vary the sorting size. The mechanism generally raises or lowers alternating conveyer bands thereby increasing the relative spacing diagonally without altering the horizontal spacing of the conveyer bands.

Heretofore, conventional size sorting apparatus that use adjustable sorting conveyers have been prone to damage the large produce before it moves off the sorting conveyer. At the end of the sorting conveyer, the alternating conveyer bands, which are raised to set the sorting size, converge downward with the other conveyer bands. The large produce carried atop the conveyer bands are often “pinched” between the converging conveyer bands at the end of the sorting conveyer. Since the larger berries are generally the ripest and most fragile, the large berries are more high susceptible to damage and bruising from being “pinched” between the converging conveyer bands at the end of the sorting conveyer.

### SUMMARY OF THE INVENTION

The present invention seeks to provide an adjustable size sorting apparatus that eliminates the produce damage and bruising caused by the produce being pinched between converging conveyer bands at the end of the sorting conveyer. The sorting apparatus embodying the present invention includes a table-like frame that supports a sorting conveyer of parallel elastic bands. The top run of the sorting conveyer is divided into two separate sorting areas. The smaller produce falls through the conveyer across the first sorting area and the remaining larger produce falls through the conveyer across the second sorting area. Since all the produce falls through the conveyer before the end of the top conveyer run, no produce is damaged. A rake mechanism ensures that all the produce falls through the conveyer before reaching the end of the top run. The table-like frame has an open bay, which accommodates the use of separate collection conveyers upon which the sorted produce falls. The sorting apparatus also includes an adjustment mechanism for setting the sort sizes that adjusts the relative spacing between the conveyer bands across one or both of the sorting areas.

Theses and other advantages of the present invention will become apparent from the following description of an embodiment of the invention with reference to the accompanying drawings.

### BRIEF DESCRIPTION OF THE DRAWINGS

The drawings illustrate an embodiment of the present invention, in which:

FIG. 1 is a side plan view of an embodiment of the present invention showing all the conveyer bands resting on the center roller;

FIG. 2 is a side plan view of the embodiment of FIG. 1 showing alternating conveyer bands lifted above the center roller;

FIG. 3 is a partial perspective view of the embodiment of FIG. 1;

FIG. 4 is partial side view of the embodiment of FIG. 1 showing the adjustment roller in its lower most position lowering alternative conveyer bands;

FIG. 5 is partial side view of the embodiment of FIG. 1 showing the adjustment roller in its upper most position, raising alternating conveyer bands;

FIG. 6 is a section view taken along line 6-6 of FIG. 2;

FIG. 7 is a section view taken along line 7-7 of FIG. 2; and

FIG. 8 is a section view taken along line 8-8 of FIG. 2.

### DESCRIPTION OF THE PREFERRED EMBODIMENT

Referring now to the drawings, a small produce sorting apparatus is generally designated as reference numeral 10. Sorting apparatus (sorter) 10 is designed to be used as a stand alone size sorting unit or as a component unit in an automated conveyer driven packaging system for small produce, such as blueberries, cherries, cherry tomatoes, radishes and similar produce. For simplicity of explanation only, sorter 10 is illustrated in the drawings and described hereafter in use in size sorting blueberries. Also, the physical dimensions and configuration of sorter 10 may vary to accommodate its application in an automated packaging system or as a stand alone unit for size sorting various types of small produce without changing the scope of the invention.

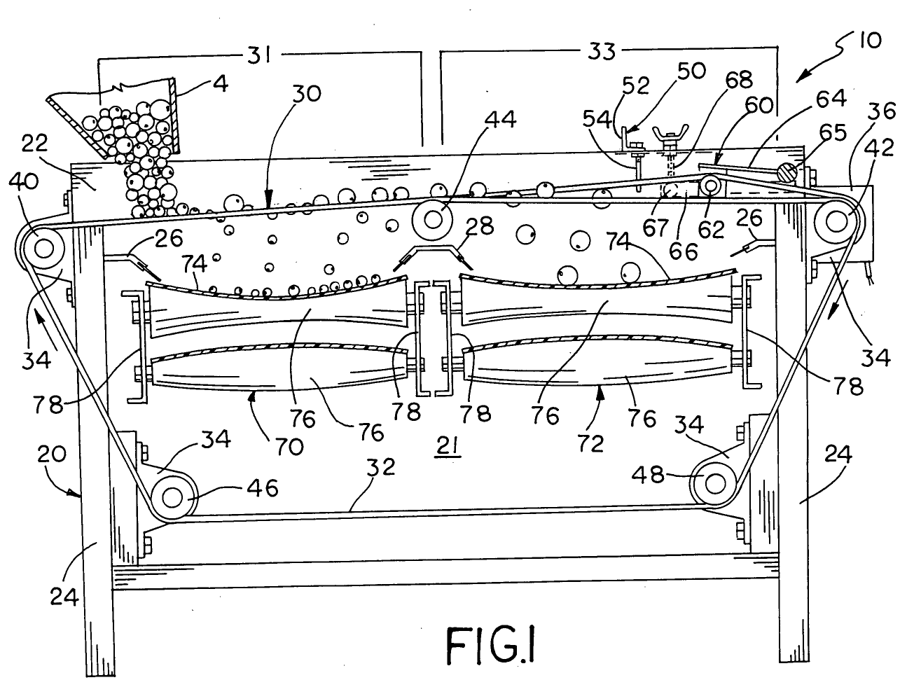

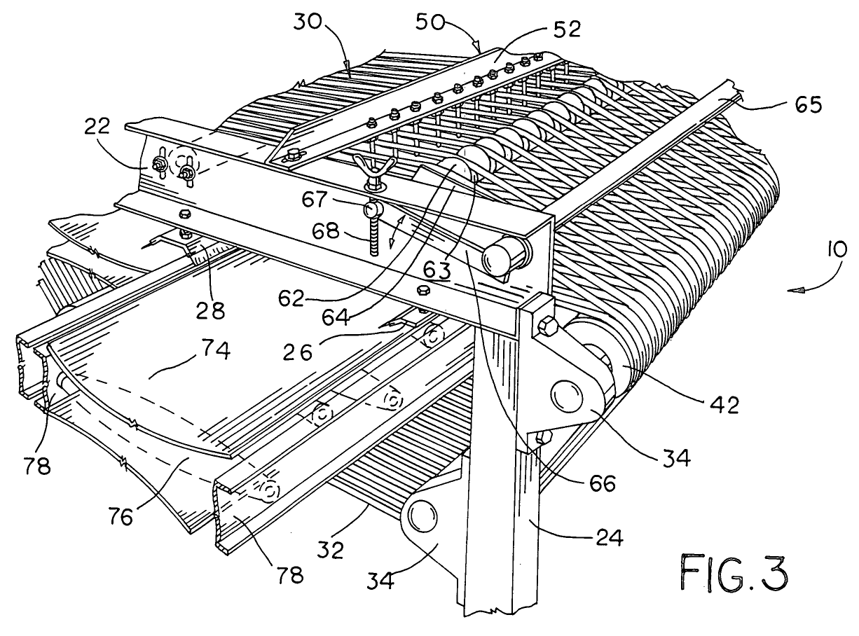

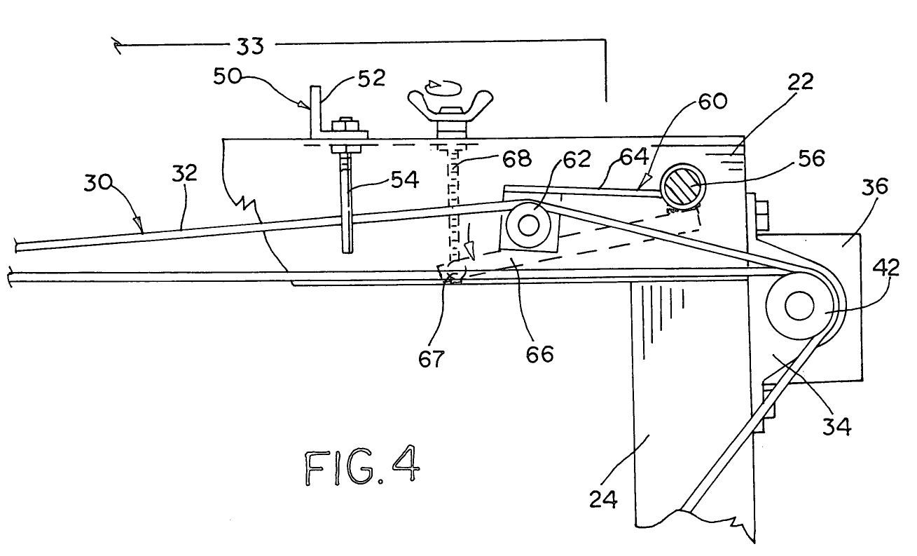

As shown in the figures, sorter 10 is built on a table-like frame 20, which includes two elevated parallel side members 22 supported by four upright legs 24. Frame 20 also generally includes a number of side and end cross braces to provide sufficient structural integrity to sorter 10. Frame 20 supports a longitudinally extending sorting conveyer, which is designated generally by reference numeral 30. Sorting conveyer 30 is formed by a plurality of continuous elastic conveyer bands 32 trained about five transverse rollers 40, 42, 44, 46 and 48 (see FIGS. 1-4). Preferably, conveyer bands 32 are constructed of suitable elastic material, such as a synthetic rubber. The ends of each conveyer band 32 are joined to form a continuous band. Each roller 40, 42, 44, 46 and 48 has a plurality of parallel annular grooves 41 in which conveyer bands 32 are seated. Grooves 41 are uniformly spaced at fixed distances along the length of the rollers and ensure that conveyer bands 32 remain trained about the rollers with fixed horizontal spacing. Rollers 40, 42, 44, 46 and 48 are journalled in bearing blocks 34 mounted to frame 20 for rotational movement transverse to the direction of sorting conveyer 30. Bearing blocks 34 of tension rollers 46 and 48 are shiftably mounted to legs 24 for adjusting the tension of conveyer bands 32. A conveyer drive motor 36 is mounted near the rear end of side members 24. Motor 36 is operatively connected to drive roller shaft 42 such that motor 36 turns the drive roller to transfer motion to conveyer bands. Typically, motor 36 is a variable speed electric motor, but any type of motor may be incorporated.

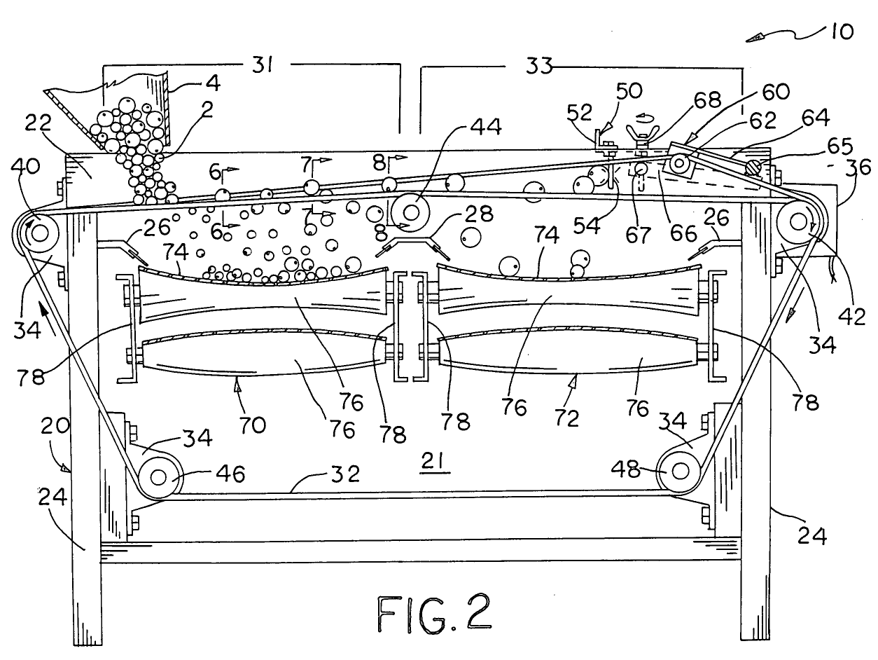

As shown in FIGS. 1 and 2, sorting conveyer 30 has a generally horizontal top run which extends the entire length of sorter 10 and a return run is spaced below the top run. The top conveyer run has a front sorting area 31 between end roller 40 and center roller 44 and a rear sorting area 33 between the center roller 44 and drive roller 42. It should be noted that center roller 44 is elevated slightly with respect to end and drive rollers 40 and 42 so that the front sorting area 31 has a slight incline and the rear sorting area 33 has a slight decline. Center roller 44 is shiftably journalled between side members 22 so that the center roller can be raised and lowered to increase or decrease the acclivity of the conveyer through sorting areas 31 and 32.

The table like design of frame 20 defines an open bay 21 between the top and return runs of sorting conveyer 30 within which the sorted berries are deposited on separate collection conveyers 70 and 72. Each collection conveyer 70 and 72 includes a continuous concave conveyer belt 74 trained about a plurality of transverse rollers 76 journalled between a pair of elongated side members 78. As shown, collection conveyers 70 and 72 extend into open bay 21 so that the direction of the collection conveyers run perpendicular to the direction of sorting conveyer 30. Collection conveyers 70 and 72 are positioned directly beneath sorting areas 31 and 33, so that blueberries 2 falling between adjacent conveyer bands 32 in each sorting area fall onto one the collection conveyers. Deflectors 26 and 28 are mounted to frame 20 within bay 21 at opposite ends of the sorter 10 and directly beneath center roller 44, respectively, to assist in directing the produce falling between adjacent conveyer bands 32 onto one of collection conveyers 70 and 72. While, sorter 10 is illustrated with collection conveyers, the sorted berries can also simply be collected in bins (not shown) supported within bay 21.

Sorter 10 includes a transverse rake 50 suspended over the top run of sorting conveyer 30, which ensures that all produce deposited on the sorting conveyer falls between conveyer bands 32 before reaching the end of the top run. Rake 50 includes a cross member 52 bolted to side members 22 and a plurality of rods 54, which are bolted to the cross member and extend downward between conveyer bands 32. Rods 54 act as the fingers or tines of rake 60.

Sorter 10 also includes a sorting size adjustment mechanism (designated generally as reference numeral 60) located near the rear of sorter 10 between center roller 44 and drive roller 42. Size adjustment mechanism 60 allows the relative spacing between adjacent conveyer bands 32 to be varied diagonally across both sorting areas 31 and 33 of the top conveyer run without altering the horizontal spacing between the bands. Size adjustment mechanism 60 includes a transverse adjustment roller 62 journaled between a pair of pivoting swing arms 64. Adjustment roller 62 has a plurality of parallel annular grooves 63 in which alternating conveyer bands 32 are seated. Swing arms 64 extend radially from a transverse pivot shaft 65, which is journalled between frame side members 22. Rotation of pivot shaft 65, pivots swing arms 64 to raise and lower adjustment roller 62. A lever arm 66 is radially connected to one end of pivot shaft 65, which protrudes through one side member 24. Lever arm 66 is manually pivoted to selectively raise and lower adjustment roller 62. As shown, the threaded shaft of adjustment bolt 68 extends downward through a longitudinal slot 23 in the flange of side member 22 and is turned into a threaded lateral bore in a barrel pin 67 rotatably seated in a lateral bore in lever arm 66. Manually turning adjustment bolt 68 pivots lever arm 66 and rotates pivot shaft 65 to raise and lower adjustment roller 62.

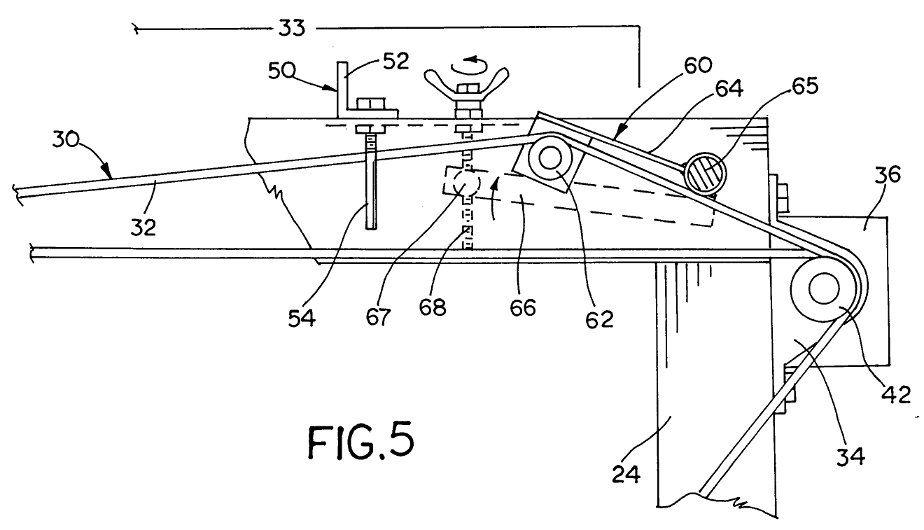

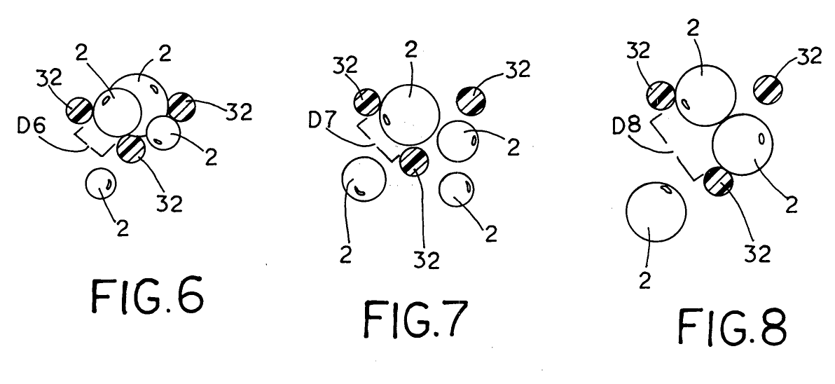

Selectively raising and lowering adjustment roller 62 varies the relative spacing (designated as D in FIGS. 6-8) between adjacent conveyer bands 32 either across rear sorting area 33 only or across both rear sorting areas 33 and front sorting area 31, as desired. Raising adjustment roller 62 lifts alternate conveyer bands 32 thereby increasing relative spacing D diagonally between adjacent conveyer bands 32. It should be noted that while relative spacing D between adjacent conveyer bands increases diagonally, the horizontal spacing of the conveyer bands remains constant, fixed by the spacing of grooves 41 in rollers 40, 42, 44, 46 and 48. Because center roller 44 is elevated with respect to end and drive rollers 40 and 42, the other conveyer bands slope downward toward drive roller 42. Consequently, relative spacing D between adjacent conveyer bands across the rear sorting area 33 is always greater than relative spacing D across the front sorting area 31. The greater relative spacing across rear sorting area 33 ensures that all blueberries fall through sorting conveyer 30. As shown in FIG. 1, relative spacing D between adjacent conveyer bands 32 across front sorting area 31 remains fixed by roller grooves 41 until the adjustment roller begins to lift alternating conveyer bands off of the center roller. As shown in FIG. 2, raising adjustment roller 62 so that alternating conveyers bands are lifted off of center roller 44 increases relative spacing D between the conveyer bands across front sorting area 31, as well as across rear sorting area 33. As shown in FIGS. 6-8, relative spacing D increases gradually across front sorting area 31 when alternating conveyer band are lifted off of center roller 44, so that progressively larger produce falls through conveyer 30. Consequently, the sorting size for front sorting area 31 is established by relative spacing D between the conveyer bands immediately before center roller 44.

It should be noted that the present invention may employ any manual or powered mechanism for adjusting the spacing between adjacent conveyer bands by raising and lowering the adjustment roller. The raising and lowering of the adjustment roller may be accomplished by a variety of conventional mechanism, including but not limited to any combination of levers, gears, screws, cams, pistons, pulleys, and solenoids.

In operation, blueberries 2 are deposited from a hopper 4 or some other transport conveyer (not shown) onto sorting conveyer 30 at the front of sorter 10. As blueberries 2 are propelled over front sorting area 31, blueberries 2 whose diameter is smaller than the relative spacing between adjacent conveyer bands 32 fall through sorting conveyer 30 onto collection conveyer 70. The remaining blueberries pass over center roller 44 and eventually fall through sorting conveyer 30 across rear sorting area 33 onto collection conveyer 72. Collection conveyers 70 and 72 carry the sorted blueberries 2 away for packaging or further processing. Typically, collection conveyers 70 and 72 run in opposite directions. As shown in FIGS. 1-2, rake 50 prevents blueberries 2 that are stuck together or jammed between adjacent conveyer bands 32 from reaching adjustment roller 62. Occasionally, two or more blueberries 2 may become physically jammed between adjacent conveyer bands 32 or physically stuck together, which prevents them from falling through sorting conveyer 30. Rods 54 extend downward between conveyer bands 32 and dislodge on contact any blueberries that may be stuck or jammed together between the conveyer bands.

### ADVANTAGES

One skilled in the art will note several advantages of the present invention over conventional adjustable conveyer-type sorting apparatus. The present invention allows all of the produce to fall through the sorting conveyer, while still sorting by size. In so doing, the present invention eliminates produce damage caused by the produce being pinching by the converging conveyer bands at the end of the sorting conveyer. The top conveyer run is divided into two separate sorting areas, where the smaller produce is collected under the front sorting area and the remaining produce is collected under the rear sorting area. The adjustment mechanism, which sets the sorting sizes uses a single adjustment roller. Raising and lowering the single adjustment roller sets the relative spacing between the conveyer bands (and thereby the sorting size) for each of the two sorting areas of the conveyer run. The open bay design of the sorter allows separate conveyers to be used to transport the sorted produce from the sorter. The rake feature ensures that all of the produce falls through the conveyer before reaching the end of the top conveyer run where produce is often pinched by the converging conveyer bands.

The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. An apparatus for sorting round produce by diameter size comprising:
a frame having a front end and a rear end; and a longitudinally extending sorting conveyer supported by the frame upon which produce is deposited,
the sorting conveyer includes a first roller transversely mounted to the frame at the first frame end for rotation relative thereto, a second roller transversely mounted to the frame at the second frame end for rotation relative thereto, a plurality of elastic conveyer bands trained about said first roller and second roller and spaced across the width of the first roller and the second roller to form a substantially horizontal top conveyer run and bottom return conveyer run, and drive means for propelling said conveyer bands about said first and second roller shafts,
the top conveyer run having a first sorting area and a second sorting area, the conveyer bands being spaced apart relative to one another so that produce deposited unto the conveyer having a diameter less a selected diameter falls through the conveyer within the first sorting area and produce deposited having a diameter greater that the selected diameter falls through the conveyer within the second sorting area.

2. The size sorting apparatus of claim 1 wherein the sorting conveyer also includes a third roller transversely mounted to the frame between the first roller and the second roller frame end and positioned so that the top conveyer passes over the third roller.

3. The size sorting apparatus of claim 2 wherein the third roller elevated with respect to the first roller and the second roller.

4. The size sorting apparatus of claim 2 wherein the first sorting area of the top conveyer run is defined between the first roller and the third roller, the second sorting area of the top conveyer run is defined between the third roller and the second roller.

5. The size sorting apparatus of claim 2 and adjustment means positioned between said second roller and the third roller for raising and lowering alternate conveyer bands to adjust the relative spacing diagonally between adjacent conveyer bands without changing the spacing horizontally between adjacent conveyer bands.

6. The size sorting apparatus of claim 1 and a rake means transversely mounted to the frame and suspended transversely over the second sorting area of the top conveyer run for ensuring that the produce falls through the sorting conveyer.

7. The size sorting apparatus of claim * wherein the rake means includes a cross member and a plurality of tines extending downward between adjacent conveyer bands of the top conveyer run.

8. The size sorting apparatus of claim 1 and means positioned beneath the top conveyer run for collecting the produce falling through the conveyer within the first sorting area and the second sorting area.

9. An apparatus for sorting blueberries by size comprising:
a frame having a front end and a rear end; and a longitudinally extending sorting conveyer supported by the frame upon which blueberries are deposited,
the sorting conveyer includes a first roller transversely mounted to the frame at the first frame end for rotation relative thereto, a second roller transversely mounted to the frame at the second frame end for rotation relative thereto, a plurality of elastic conveyer bands trained about said first roller and second roller and spaced across the width of the first roller and the second roller to form a substantially horizontal top conveyer run and bottom return conveyer run, and drive means for propelling said conveyer bands about said first and second roller shafts,
the top conveyer run having a first sorting area and a second sorting area, the conveyer bands being spaced apart relative to one another so that blueberries deposited unto the conveyer having a diameter less a selected diameter falls through the conveyer within the first sorting area and blueberries deposited having a diameter greater that the selected diameter falls through the conveyer within the second sorting area.

10. The size sorting apparatus of claim 9 wherein the sorting conveyer also includes a third roller transversely mounted to the frame between the first roller and the second roller frame end and positioned so that the top conveyer passes over the third roller.

11. The size sorting apparatus of claim 10 wherein the third roller elevated with respect to the first roller and the second roller.

12. The size sorting apparatus of claim 10 wherein the first sorting area of the top conveyer run is defined between the first roller and the third roller, the second sorting area of the top conveyer run is defined between the third roller and the second roller.

13. The size sorting apparatus of claim 10 and adjustment means positioned between said second roller and the third roller for raising and lowering alternate conveyer bands to adjust the relative spacing diagonally between adjacent conveyer bands without changing the spacing horizontally between adjacent conveyer bands.

14. The size sorting apparatus of claim 9 and a rake means transversely mounted to the frame and suspended transversely over the second sorting area of the top conveyer run for ensuring that the blueberries fall through the sorting conveyer.

15. The size sorting apparatus of claim 14 wherein the rake means includes a cross member and a plurality of tines extending downward between adjacent conveyer bands of the top conveyer run.

16. The size sorting apparatus of claim 9 and means positioned beneath the top conveyer run for collecting the blueberries falling through the conveyer within the first sorting area and the second sorting area.

17. An apparatus for sorting blueberries by size comprising:
a frame having a front end and a rear end;
a longitudinally extending sorting conveyer supported by the frame upon which blueberries are deposited,
the sorting conveyer includes a first roller transversely mounted to the frame at the first frame end for rotation relative thereto, a second roller transversely mounted to the frame at the second frame end for rotation relative thereto, a third roller transversely mounted to the frame between the first roller and the second roller frame end and positioned so that the top conveyer passes over the third roller, a plurality of elastic conveyer bands trained about said first roller and second roller and spaced across the width of the first roller and the second roller to form a substantially horizontal top conveyer run and bottom return conveyer run, and drive means for propelling said conveyer bands about said first and second roller shafts,
the top conveyer run having a first sorting area defined between the first roller and the third roller and a second sorting area defined between the third roller and the second roller, the conveyer bands being spaced apart relative to one another so that blueberries deposited unto the conveyer having a diameter less a selected diameter falls through the conveyer within the first sorting area and blueberries deposited having a diameter greater that the selected diameter falls through the conveyer within the second sorting area;
adjustment means positioned between said second roller and the third roller for raising and lowering alternate conveyer bands to adjust the relative spacing diagonally between adjacent conveyer bands without changing the spacing horizontally between adjacent conveyer bands; and
rake means transversely mounted to the frame and suspended transversely over the second sorting area of the top conveyer run for ensuring that the blueberries fall through the sorting conveyer.

18. The size sorting apparatus of claim 17 wherein the third roller elevated with respect to the first roller and the second roller.

19. The size sorting apparatus of claim 17 wherein the rake means includes a cross member and a plurality of tines extending downward between adjacent conveyer bands of the top conveyer run.

20. The size sorting apparatus of claim 17 and means positioned beneath the top conveyer run for collecting the blueberries falling through the conveyer within the first sorting area and the second sorting area.
